(19) United States
(12) Patent Application Publication
(10) Pub. No.: US 2007/0241271 A1
(43) Pub. Date: Oct. 18, 2007

(54) Reflection-based optical encoders having no code medium

(76) Inventors: Yee Loong Chin, Perak (MY); Kean Foong Ng, Penang (MY); Weng Fei Wong, Penang (MY)

Correspondence Address: Kathy Manke;Avago Technologies Limited, 4380 Ziegler Road, Fort Collins, CO, 80525, US

(21) Appl. No.: 11/404,111

(22) Filed: Apr. 14, 2006

(51) Int. Cl. G01D 5/34

(52) U.S. Cl. 250/231.13

(57) ABSTRACT

A reflection-based optical encoding apparatus for the detection of position and/or motion of a mechanical device is described. In various embodiments, such a reflection-based optical encoding apparatus can include an encoder housing having one or more portions, a light-emitting source embedded within the encoder housing, and a light-detecting sensor embedded within the encoder housing, wherein the encoder housing includes one or more optical elements configured to enable light generated by the light-emitting source to reflect on a moveable object placed in close proximity of the encoder housing and subsequently be received by the light-detecting sensor to enable the reflection-based optical encoding apparatus to sense at least one of position and motion of the moveable object, and wherein the reflection-based optical encoding apparatus includes no codescale within the light path of the light-emitting source and the light-detecting sensor.

### BACKGROUND

The present disclosure relates to an optical encoding device for the sensing of position and/or motion.

Optical encoders are used in a wide variety of contexts to determine position and/or movement of an object with respect to some reference. Optical encoding is often used in mechanical systems as an inexpensive and reliable way to measure and track motion among moving components. For instance, printers, scanners, photocopiers, fax machines, plotters, and other imaging systems often use optical encoders to track the movement of an image media, such as paper, as an image is printed on the media or an image is scanned from the media.

Generally, an optical encoder includes some form of light emitter/detector pair working in tandem with a “codewheel” or a “codestrip”. Codewheels are generally circular and can be used for detecting rotational motion, such as the motion of a paper feeder drum in a printer or a copy machine. In contrast, codestrips generally take a linear form and can be used for detecting linear motion, such as the position and velocity of a print head of the printer. Such codewheels and codestrips generally incorporate a regular pattern of slots and bars depending on the form of optical encoder.

While optical encoders have proved to be a reliable technology, there still exists substantial industry pressure to simplify manufacturing operations, reduce the number of manufacturing processes, minimize the number of parts and minimize the operational space. Accordingly, new technology related to optical encoders is desirable.

### SUMMARY

In an embodiment first sense, a reflection-based optical encoding apparatus for the detection of position and/or motion of a mechanical device includes an encoder housing having one or more portions, a light-emitting source embedded within the encoder housing, and a light-detecting sensor embedded within the encoder housing, wherein the encoder housing includes one or more optical elements configured to enable light generated by the light-emitting source to reflect on a moveable object placed in close proximity of the encoder housing and subsequently be received by the light-detecting sensor to enable the reflection-based optical encoding apparatus to sense at least one of position and motion of the moveable object, and wherein the reflection-based optical encoding apparatus includes no codescale within the light path of the light-emitting source and the light-detecting sensor.

In another embodiment, a reflection-based optical encoding apparatus for the detection of position and/or motion of a mechanical device without the use of a codescale includes an encoder housing having one or more portions, a light-emitting source embedded within the encoder housing, and a light-detecting sensor embedded within the encoder housing, wherein the light-detecting sensor includes a linear array of light-detecting elements, wherein the encoder housing includes one or more optical elements configured to enable light generated by the light-emitting source to reflect on a moveable object placed in close proximity of the encoder housing and subsequently be received by the light-detecting sensor to enable the reflection-based optical encoding apparatus to sense at least one of position and motion of the moveable object, and wherein the reflection-based optical encoding apparatus includes no codescale within the light path of the light-emitting source and the light-detecting sensor.

In yet another embodiment, an optical encoding apparatus for the detection of position and/or motion of a mechanical device includes an encoder housing having one or more portions, a light-emitting source embedded within the encoder housing, the light-emitting source being configured to emit a substantially linear pattern of light, a light-detecting sensor embedded within the encoder housing, wherein the light-detecting sensor includes a linear array of light-detecting elements, a first optical means for directing light generated by the light-emitting source to a moveable object placed in close proximity of the encoder housing, and a second optical means for directing light generated by the light-emitting source and reflected by the moveable object to the light-detecting sensor.

In another embodiment, a method for calibrating a mechanical device having an optical encoding apparatus includes capturing a plurality of optical profiles of a first surface of the mechanical device as the first surface is moved along a known travel path, wherein the first surface is used as a reflective element to complete an optical light path between an optical emitter and an optical detector of the optical encoding apparatus, wherein the first surface has no codescale falling within the optical light path and affecting the functionality of the optical encoding apparatus, associating each captured profile with an absolute position of the first surface and creating a database with each entry having at least a first field containing optical profile information and a second field containing a respective absolute position of the first surface such that a processing system accessing the database can determine the absolute position of the first surface using a subsequently captured optical profile as a reference, wherein the optical detector includes an linear array of optical detection elements, and wherein each optical profile represents a linear pattern of light reflected from the first surface at a particular respective position.

### DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 shows a first reflection-based optical encoder;

FIGS. 2A and 2B depict two different optical detectors;

FIG. 3A shows a first novel reflection-based optical encoder not having an encoding medium monitoring a linear body;

FIG. 3B shows the reflection-based optical encoder of FIG. 3A monitoring a cylindrical body;

FIG. 3C shows the first novel reflection-based optical encoder of FIG. 3A monitoring a disk-like body;

FIG. 4 shows a second novel reflection-based optical encoder not having an encoding medium;

FIG. 5 shows details of an optical emitter for use with the disclosed methods and systems;

FIG. 6 shows details of an optical detector for use with the disclosed methods and systems; and

FIG. 7 is a flowchart outlining an exemplary process according to the present disclosure.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparatus and methods may be omitted so as to not obscure the description of the example embodiments. Such methods and apparatus are clearly within the scope of the present teachings.

Optical encoders are generally classified into two categories: transmission-based optical encoders and reflection-based optical encoders. The following disclosure is generally directed to reflection-based optical encoders. However, it should be appreciated that there will be pertinent concepts that may readily apply to transmission-based encoders as well.

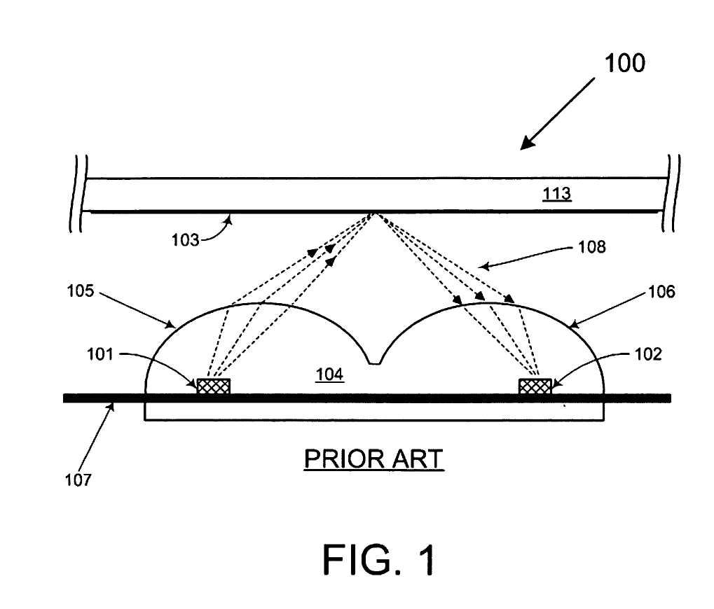

FIG. 1 shows a reflection-based optical encoder 100. The reflection-based encoder 100 includes an optical emitter 101 and an optical detector 102 mounted on a leadframe 107 and encapsulated in an optical housing 104, which is typically made from some form of resin or glass. The exemplary optical housing 104 has two dome-shaped surfaces, with the first dome-shaped surface 105 directly above the optical emitter 101 and the second dome-shaped surface 106 directly above the optical detector 102. A codescale 103, such as a codewheel, a codestrip or similar device, is positioned above the housing 104 on body 113, which for the present example can be a flat body capable of moving in a linear fashion.

In operation, light emitted by the optical emitter 101 can be focused by the first dome-shaped surface 105 (which can act as a lens), then transmitted to the codescale 103. Should the codescale 103 be positioned such that a reflective slot/bar is present along the path of the transmitted light, the transmitted light can be reflected to the second dome-shaped surface 106 (which also can act as a lens) and focused by the second dome-shaped surface 106 onto the optical detector 102 where it can be detected. Should the codescale 103 be positioned such that a no reflective slotbar is present along the path of the transmitted light, the transmitted light will be effectively blocked, and the optical detector 102 can detect the absence of light. Should the codescale 103 be configured such that a combination of reflective and non-reflective bars is simultaneously present along the path of the transmitted light, the codescale 103 can reflect light commensurate with the pattern of reflective and non-reflective bars such that the pattern is effectively projected onto the optical detector 102.

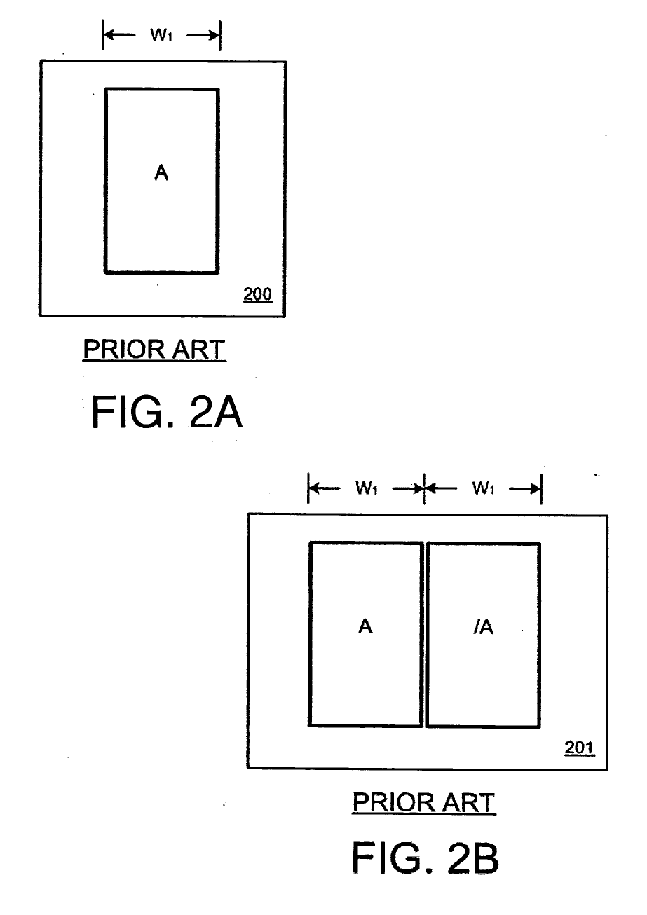

Generally, it should be appreciated that all conventional optical encoders use some form of codescale. It should also be appreciated that conventional optical encoders also use either single-element detectors or detectors having a low number of optical detection elements. By way of example, FIG. 2A shows such a detector 200 for use in an optical encoder, such as the encoder 100 of FIG. 1. As shown in FIG. 2A, the optical encoder 200 has a single optical detection element {A} having a width W₁ and being capable of producing two discrete states: 0 and 1. FIG. 2B shows a second detector 200 for use in an optical encoder. As shown on FIG. 2B, the detector 201 has two light-detecting elements {A, /A}. Given the series of windows and bars shown superimposed over the light-sensing elements {A, /A}, the states produced by detection elements {A, /A} can alternate between {1, 0} and {0, 1} for every interval W₁ traveled by the codescale. The detector 201 has an advantage over the detector 200 of FIG. 2A in that it can provide a differential output, and thus improve the signal-to-noise ratio of an optical detection system.

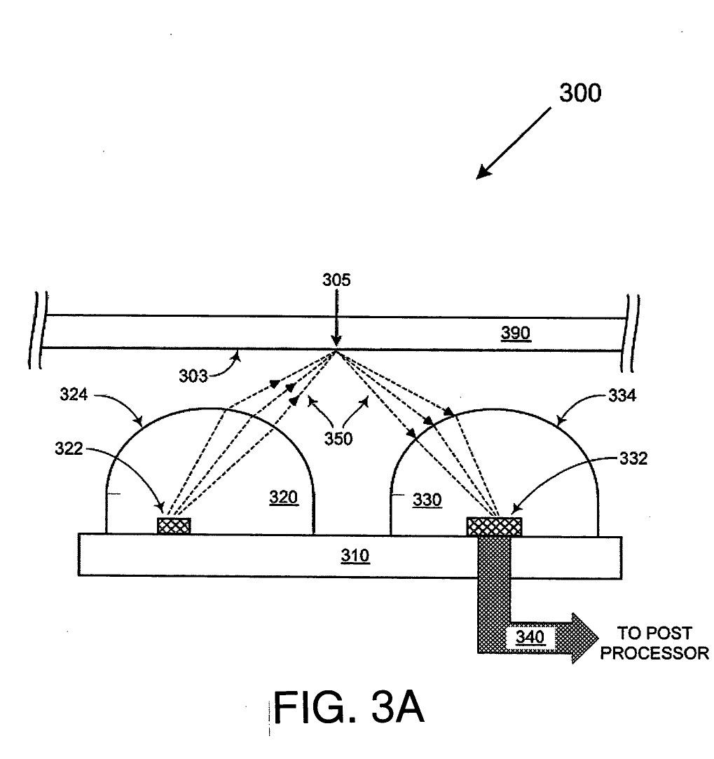

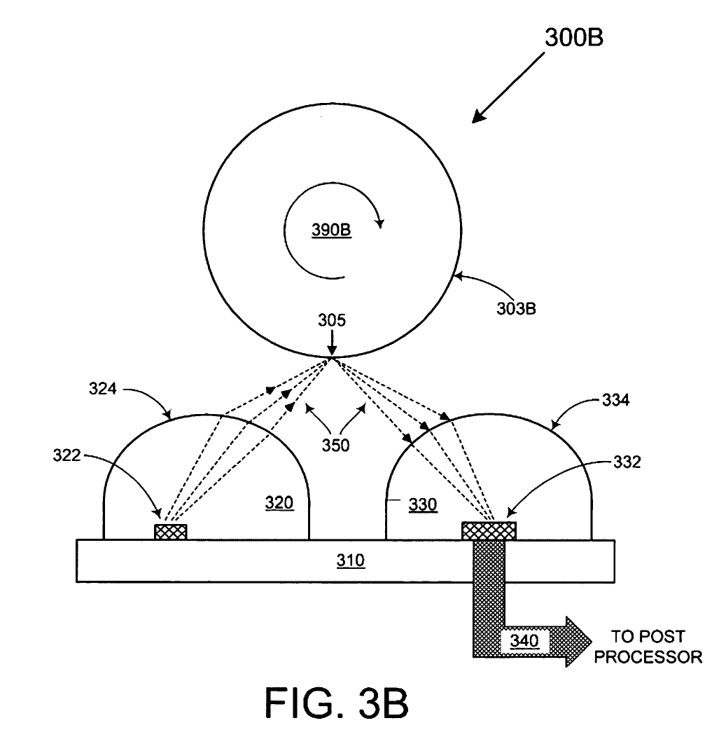

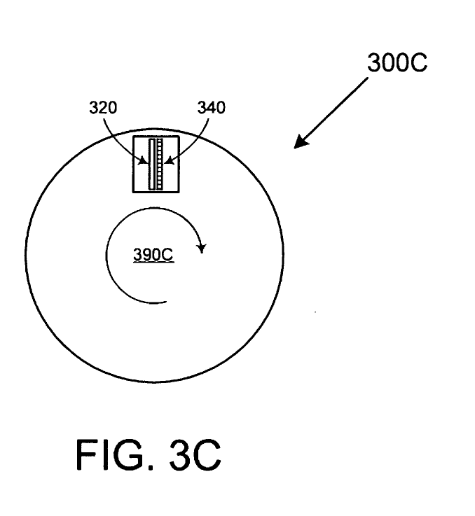

FIG. 3A shows a novel flat-top reflection-based optical encoder 300. As shown in FIG. 3A, the optical encoder 300 includes an optical emitter 322 and an optical detector 332 mounted on a common substrate 310. The optical emitter 322 is encapsulated in a first optical housing 320, and the optical detector 332 is encapsulated in a second optical housing 330. A first optical dome 324 is incorporated into the first housing 320, and a second dome 334 is incorporated into the second housing 330. While not explicitly shown in FIG. 3 due to the cross-sectional perspective, the first and second housings 320 and 330 are elongated bodies and the domes 324 and 334 are both elongated, cylindrical shapes. Although the exemplary housing configuration of the present optical encoder 300 uses two separate housings 320 and 330, it should be appreciated that these housings 320 and 330 can be integrated to a single body without departing from the spirit and scope of the disclosed methods and systems. The optical encoder 300 further includes a link 340 connecting the optical detector 332 to an external post processor (not shown), and a linearly traveling object 390 having a lower surface 303 (sans codescale) is placed in an appropriate proximity to the first and second housings 320 and 330.

In operation, light emitted by the optical emitter 322 can be focused by the first dome-shaped surface 324 (which can act as a lens) to be transmitted to the lower surface 303 at location 305. Given the generally elongated structure of the exemplary optical encoder 300 (with elongated emitter 322 and dome 324), it should be appreciated that the light focused on location 305 can similarly take an elongated line-shaped form, as opposed to a single round or square-ish spot of the detectors of FIGS. 2A and 2B. Upon reaching location 305, the incident line-shaped of light can be reflected back to the second dome 334 (which also can act as a lens), which can in turn focus the reflected line-shaped light upon the detector 332. The operational path 350 of the encoder's light is illustrated in FIG. 3 with the understanding that the operational path 350 shown is but is a cross-sectional view.

Given that there is no codescale on object 390, the amount of light reflected from location 305 can vary as a function of varying texture, reflectivity or some other property of surface 303. Such varying properties can be the result of any combination of natural/random processes induced in a fabrication process as well as due to any processes intentionally induced during or after fabrication. Given these variations in texture, reflectivity etc, it should be appreciated that for any particular position of object 390, the amount of light reflected at any point along the line running along a transverse direction (i.e., along the axis perpendicular to the plane of FIG. 3A and perpendicular to the direction of travel of object 390) at location 305 can vary, and thus a line of light at location 305 may have a unique and identifiable profile for various positions along body 390.

While each point received by a detector element can be measured and stored as a discreet 0/1 bit (based on some threshold), given that each particular point of light can have a continuous range of intensity and that a detector can also have a continuous transfer function for a range of light intensity, it should be appreciated that the output of a detector element can be digitally sampled and stored to produce a multi-bit number more representative of the actual amount of light reflected onto the respective element.

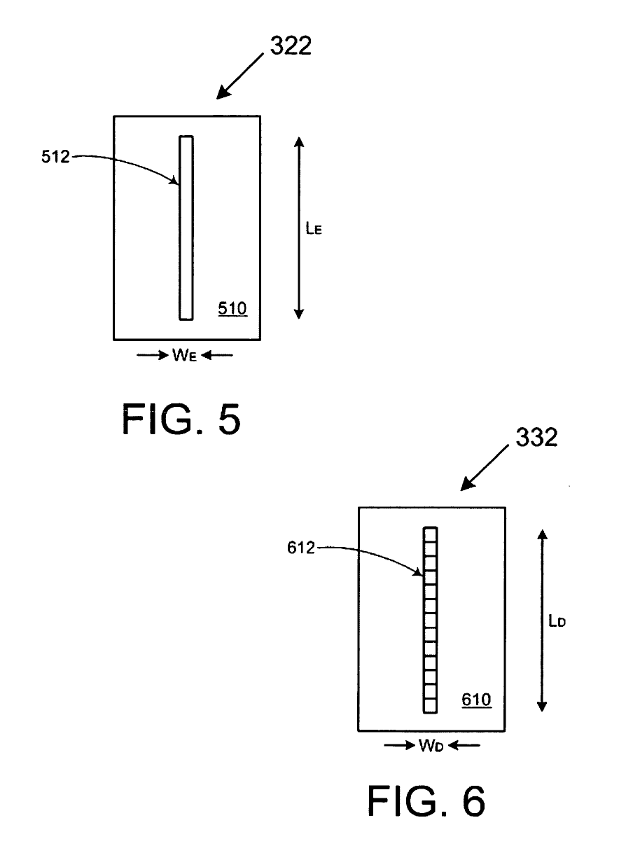

FIG. 5 depicts a top view of an exemplary optical emitter 322 useful for operation in the various disclosed methods and systems. As shown in FIG. 5, the exemplary optical emitter 322 has a generally elongated form with a linear emitting portion 512, e.g., a slit, embedded in an emitter body 510. Similarly, FIG. 6 depicts a complementary, exemplary optical detector 332 useful for operation in the various disclosed methods and systems. As shown in FIG. 6, the exemplary optical detector 322 has a series of optical detection elements 612 embedded in a detector body 610.

While the exact dimensions (L by W) of the linear emitting portion 512 or the array of optical detection elements 612 may not be critical for all embodiments, it should be appreciated that better performance may be had with a longer L dimension in certain embodiments as compared to the W dimension.

It should also be appreciated that the number of detection elements in the array of optical detection elements 612 can also have an effect on system performance and that such effect may not be immediately apparent or predictable. For example, using ten detection elements in a detection array may provide five times the performance at twice the required post-processing as compared to using five detection elements, while using twenty detection elements may only provide marginal performance enhancement compared to using ten elements at twice the required post-processing.

Still further, it should also be appreciated that the sampling resolution as well as the number of detectors can have a performance effect on a system, and that there can be tradeoffs between sampling resolution and the number of elements. For example, should sampling resolution be limited to one bit (0/1), over one-hundred detection elements may be necessary to achieve a given performance goal. However, the same performance goals might also be satisfied with four detection elements sampling at eight bits [0 . . . 255] or even two detection elements sampling at twelve bits [0 . . . 4095].

While it is envisioned that the linear emitting portion 512 of FIG. 5 can generate a generally even light profile across length LE, it should also be appreciated that other linear profiles might be useful. For example, a series of light-emitting segments separated from one another by a constant distance and aligned in a straight line (or even a somewhat curved line) might alternatively be used when used with a complementary detector. With this in mind, the exemplary detector 332 of FIG. 6 might be replaced with a series of linearly aligned detection elements also dispersed by a constant distance from one another.

Still further, while the exemplary optical domes 324 and 334 are envisioned to be smooth devices of cylindrical geometries, the optical domes can in various embodiments take variations of cylindrical devices. For example, in a particular embodiment optical dome 334 can take the form of generally spherical domes aligned in a row to service appropriately spaced separate detection elements. Accordingly, it should be appreciated that for the purpose of this disclosure, the term “generally cylindrical” can refer not only to a variety of elongated shapes having a generally uninterrupted, smooth surface, but to elongated devices having repeated patterns (e.g., a string of aligned beads) that still meet the general criteria elongated and non-spherical geometries.

FIG. 3B depicts a variation exemplary optical encoder 300B that varies slightly from the encoder 300 of FIG. 3A. As shown in FIG. 3B, the optical encoder 300B differs only in that the linear, flat object 390 is replaced by a drum-like object 390B having a circular outer surface 303B. FIG. 3C depicts another slight variant optical encoder 300C where the linear, flat object 390 is replaced by a spinning disk 390C.

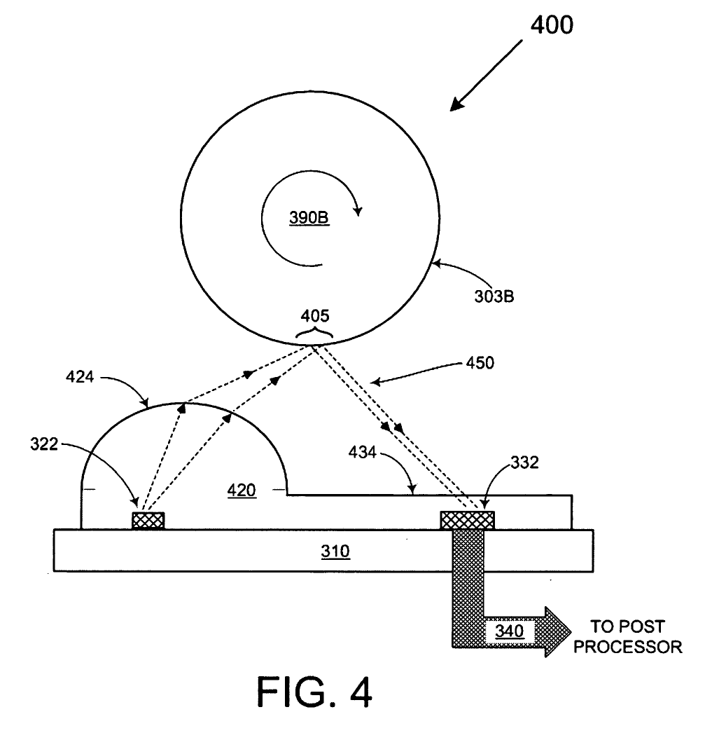

FIG. 4 depicts yet another exemplary optical encoder 400. As shown in FIG. 4, second exemplary optical encoder 400 has includes an optical emitter 322 and an optical detector 332 mounted on a common substrate 310. The optical emitter 322 and optical detector 334 are encapsulated in a common optical housing 420. An optical dome 424 is incorporated into the housing 420 above the emitter 322, and a flat facet 432 is incorporated into the housing 420 above the detector 332. As with the example of FIG. 3, the various components of present optical encoder 400 can take generally elongated/cylindrical shapes.

The operation of the second exemplary optical encoder 400 can be substantially the same as with the examples associated with FIG. 3A. However, the optics of the present example are slightly different in that the overall optical system is designed to produce a light path 450 that is projected onto a broader region of the drum's surface 303 at location 405, and reflected back to the detector 332 as a generally collimated beam of light. By using this approach, the need for a second domed/cylindrically shaped lens can be eliminated.

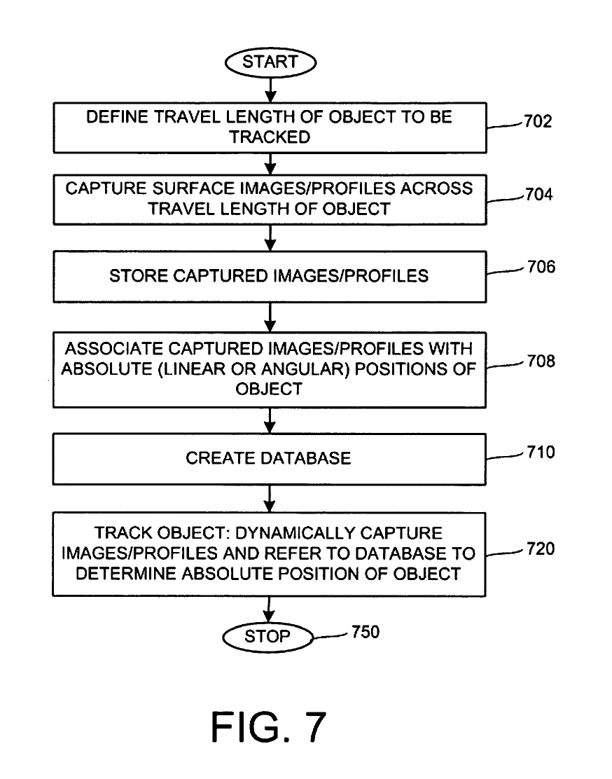

FIG. 7 is a flowchart outlining an exemplary operation for calibrating and using optical encoders not having a codescale, such as any of the optical encoders described above. The process starts at step 702 where the travel length of the object to be tracked is defined. As discussed above, objects to be tracked can take any number of forms, such as linear forms, rotating drums, spinning disks and so on. As also discussed above, such objects can have a variety of surface textures/patterns such that when the object is placed in proximity to an encoder body having an elongated light emitter and light detector having a plurality of light detection elements, the body can provide a variety of reflected light patterns/images/profiles to the detector. Control continues to step 704.

In step 704, patterns/images/profiles can be captured by the detector as the object is moved relative to the encoder body, and in step 706 the patterns/images/profiles can be stored in a memory. Next, in step 708, various captured and stored patterns/images/profiles can be associated with respective absolute positions or angles of the object to be tracked. Then, in step 710, an association database can be created with the entries including the fields of: (1) the various patterns/images/profiles (or some form of derivative information), and (2) respective absolute positions/angles. Control continues to step 720.

In step 720, the tracked object can be used in normal operation with the codescale-less encoder tracking the object by repeatedly sampling the encoder's detector and referencing the database of step 710 to determine the absolute position of the object. This tracking operation can continue until no longer desired or needed, and control then continues to step 750 where the process stops.

Regarding resolution performance issues, it should be appreciated that the more samples taken of the tracked object as it is moved from one position to another, the greater the potential tracking resolution. For example, should a spinning drum be measured every 0.01 degree for a total of 36,000 measurements, one might expect to have finer tracking resolution than if the spinning drum were sampled every 0.1 degree.

However, in various embodiments where the reflective structure of the spinning disk is known to change relatively smoothly from point to point, finer resolution may be had by employing interpolation routines. By way of a simplified example, if the measured/stored output of a detection element on a spinning disk were 2.0 mA at a 10 degree angle and 3.0 mA at 10.1 degree angle, a signal processing element registering an output of 2.2 mA might determine that the spinning disk was at a 10.02 degree angle.

While example embodiments are disclosed herein, one of ordinary skill in the art appreciates that many variations that are in accordance with the present teachings are possible and remain within the scope of the appended claims. The embodiments therefore are not to be restricted except within the scope of the appended claims.

1. A reflection-based optical encoding apparatus for the detection of position and/or motion of a mechanical device, the apparatus comprising:
an encoder housing having one or more portions;
a light-emitting source embedded within the encoder housing; and
a light-detecting sensor embedded within the encoder housing;
wherein the encoder housing includes one or more optical elements configured to enable light generated by the light-emitting source to reflect on a moveable object placed in close proximity of the encoder housing and subsequently be received by the light-detecting sensor to enable the reflection-based optical encoding apparatus to sense at least one of position and motion of the moveable object;
wherein the reflection-based optical encoding apparatus includes no codescale within the light path of the light-emitting source and the light-detecting sensor.

2. The optical encoding apparatus of claim 1, wherein the light-detecting sensor includes a linear array of light-detecting elements that runs in a direction transverse to a direction of travel of the moveable object.

3. The optical encoding apparatus of claim 2, wherein the one or more optical elements is configured to direct light generated by the light-emitting source onto the linear array of light-detecting elements such that each element of the linear array can receive light reflected from a different portion of the moveable object.

4. The optical encoding apparatus of claim 3, wherein the light-emitting source is configured to emit light having a line-like pattern.

5. The optical encoding apparatus of claim 4, wherein the light-emitting source is configured to emit light having dimensions on m by n, where m is at least 5 times greater than n.

6. The optical encoding apparatus of claim 4, wherein the one or more optical elements includes a first cylindrical lens placed in close proximity to the light-emitting source, the first cylindrical lens being configured to direct a substantially even line of light from the light-emitting source onto the moveable object.

7. The optical encoding apparatus of claim 6, wherein the one or more optical elements further includes a second cylindrical lens placed in close proximity to the light-detecting sensor, the second cylindrical lens being configured to receive a line of light generated by the light-emitting source and reflected from the moveable object, and direct the reflected light onto multiple elements of the light-detecting sensor.

8. The optical encoding apparatus of claim 7, wherein the second cylindrical lens is configured to focus the reflected light onto the light-detecting sensor.

9. The optical encoding apparatus of claim 6, wherein the a first cylindrical lens is configured in such a manner such that light generated by the light-emitting source and reflected from the moveable object to the light-detecting sensor is substantially collimated.

10. The optical encoding apparatus of claim 9, wherein the wherein the one or more optical elements further includes a substantially flat facet placed in close proximity to the light-detecting sensor.

11. The optical encoding apparatus of claim 9, wherein the moveable object is cylindrical, and the wherein the light generated by the light-emitting source and received by the light-detecting sensor reflects upon an outer, curved surface of the moveable object.

12. The optical encoding apparatus of claim 2, wherein the moveable object is cylindrical, and the wherein the light generated by the light-emitting source and received by the light-detecting sensor reflects upon an outer, curved surface of the moveable object.

13. A reflection-based optical encoding apparatus for the detection of position and/or motion of a mechanical device without the use of a codescale, the apparatus comprising:
an encoder housing having one or more portions;
a light-emitting source embedded within the encoder housing; and
a light-detecting sensor embedded within the encoder housing, wherein the light-detecting sensor includes a linear array of light-detecting that runs in a direction transverse to a direction of travel of the moveable object;
wherein the reflection-based optical encoding apparatus includes no codescale within the light path of the light-emitting source and the light-detecting sensor.

14. The optical encoding apparatus of claim 13, wherein the one or more optical elements is configured to direct light a line of light generated by the light-emitting source onto the linear array of light-detecting elements such that each element of the linear array of light-detecting elements can receive light reflected from a different portion of the moveable object.

15. The optical encoding apparatus of claim 14, wherein the one or more optical elements is configured to direct light a line of light generated by the light-emitting source onto the linear array of light-detecting elements in at least one of a focused or collimated manner.

16. An optical encoding apparatus for the detection of position and/or motion of a mechanical device, the apparatus comprising:
an encoder housing having one or more portions;
a light-emitting source embedded within the encoder housing, the light-emitting source being configured to emit a substantially linear pattern of light;
a light-detecting sensor embedded within the encoder housing, wherein the light-detecting sensor includes a linear array of light-detecting elements;
a first optical means for directing light generated by the light-emitting source to a moveable object placed in close proximity of the encoder housing; and
a second optical means for directing light generated by the light-emitting source and reflected by the moveable object to the light-detecting sensor.

17. The optical encoding apparatus of claim 16, wherein the moveable object is cylindrical, and the wherein the light generated by the light-emitting source and received by the light-detecting sensor reflects upon an outer, curved surface of the moveable object.

18. The optical encoding apparatus of claim 17, wherein the second optical means is configured to focus light received from the moveable object onto the light-detecting sensor.

19. The optical encoding apparatus of claim 17, wherein first optical means is configured to generate a substantially collimated beam of light in conjunction with the outer, curved surface of the moveable object, the substantially collimated beam being directed to the light-detecting sensor.

20. A method for calibrating a mechanical device having an optical encoding apparatus, the method comprising:
capturing a plurality of optical profiles of a first surface of the mechanical device as the first surface is moved along a known travel path, wherein the first surface is used as a reflective element to complete an optical light path between an optical emitter and an optical detector of the optical encoding apparatus, wherein the first surface has no codescale falling within the optical light path and affecting the functionality of the optical encoding apparatus;
associating each captured profile with an absolute position of the first surface; and
creating a database with each entry having at least a first field containing optical profile information and a second field containing a respective absolute position of the first surface such that a processing system accessing the database can determine the absolute position of the first surface using a subsequently captured optical profile as a reference;
wherein the optical detector includes an linear array of optical detection elements, and wherein each optical profile represents a linear pattern of light reflected from the first surface at a particular respective position.

21. The method of claim 20, further comprising the step of performing an interpolation operation using two separate entries of the database to improve position resolution of the optical encoding apparatus.
